(19) United States
(12) Patent Application Publication
(10) Pub. No.: US 2023/0421229 A1
(43) Pub. Date: Dec. 28, 2023

(54) METHODS FOR UE TO REQUEST GNB TCI STATE SWITCH FOR BLOCKAGE CONDITIONS

(71) Applicant: QUALCOMM Incorporated, San Diego, CA (US)

(72) Inventors: Vasanthan RAGHAVAN, West Windsor Township, NJ (US); Tianyang BAI, Somerville, NJ (US)

(21) Appl. No.: 17/808,923

(22) Filed: Jun. 24, 2022

(51) Int. Cl. H04B 7/06; H04W 72/12; H04L 5/00

(52) U.S. Cl. CPC H04B 7/0695; H04W 72/1263; H04L 5/0053

(57) ABSTRACT

Method and apparatus for a UE to request a TCI state switch for blockage conditions. The apparatus predicts a blockage condition to a first beam communicating with a network node. The apparatus transmits, to the network node, a beam switch indication indicating a scheduled change in a TCI state mapped from the first beam to a second beam in response to the predicted blockage condition. The apparatus may schedule a beam change to the second beam based on the predicted blockage condition. The apparatus may correlate a beam change to the second beam at the UE with a corresponding beam change at the network node.

### TECHNICAL FIELD

The present disclosure relates generally to communication systems, and more particularly, to a configuration for a user equipment (UE) to request a transmission configuration indicator (TCI) state switch for blockage conditions.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a device at a UE. The device may be a processor and/or a modem at a UE or the UE itself. The apparatus predicts a blockage condition to a first beam communicating with a network node. The apparatus transmits, to the network node, a beam switch indication indicating a scheduled change in a transmission configuration indicator (TCI) state mapped from the first beam to a second beam in response to the predicted blockage condition.

In an aspect of the disclosure, a method, a computer-readable medium, and an apparatus are provided. The apparatus may be a device at a network node. The device may be a processor and/or a modem at a network node or the network node itself. The apparatus communicates with a UE using a first beam. The apparatus obtains a beam switch indication comprising a scheduled change in a transmission configuration indicator (TCI) state mapped from the first beam to a second beam for the UE based on a predicted blockage condition to the first beam.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4A is a diagram illustrating an example of a UE.

FIG. 4B is a diagram illustrating an example of a UE.

FIG. 5 is a diagram illustrating an example of a UE communicating with an artificial intelligence (AI)/machine learning (ML) framework.

FIG. 6 is a diagram illustrating an example of an AI/ML algorithm used in connection with wireless communication.

FIG. 7 is a call flow diagram of signaling between a UE and a base station.

FIG. 8 is a flowchart of a method of wireless communication.

FIG. 9 is a flowchart of a method of wireless communication.

FIG. 10 is a diagram illustrating an example of a hardware implementation for an example apparatus and/or network node.

FIG. 11 is a flowchart of a method of wireless communication.

FIG. 12 is a flowchart of a method of wireless communication.

FIG. 13 is a diagram illustrating an example of a hardware implementation for an example network node.

### DETAILED DESCRIPTION

In wireless communications, multi-antenna beamforming is commonly used in frequency range 2 (FR2) or millimeter wave systems. In beyond-5G systems, multi-antenna beamforming could be used at frequency range 3 (FR3), frequency range 4 (FR4) or frequency range 5 (FR5) in addition to being used at FR2. Blockage of a directional beam used for wireless communication may reduce/degrade the link performance, such as in FR2 wireless communication systems. Blockage of a beam may occur due to a user's interaction with a UE, such as a user's hand, fingers, head, or other body parts blocking the path the UE and a network node or other UE. Blockage may also occur due to external objects, such as other people, vehicles, buildings, foliage, terrain, etc. blocking a beam direction between a UE and a network node or other UE. The onset of the blockage may be relatively slow or fast, e.g., the time-scales of change may be on the order of a few 10s to 100s of ms. Beam blockage may degrade the link performance and the level of degradation may be affected by the blockage mode.

Aspects presented herein provide a configuration for a UE to request a TCI state switch for blockage conditions. The aspects presented herein allow for a UE to predict a blockage condition to a beam used for the UE to communicate with a network node, such that the UE may schedule a beam switch at the UE based on the predicted blockage condition.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

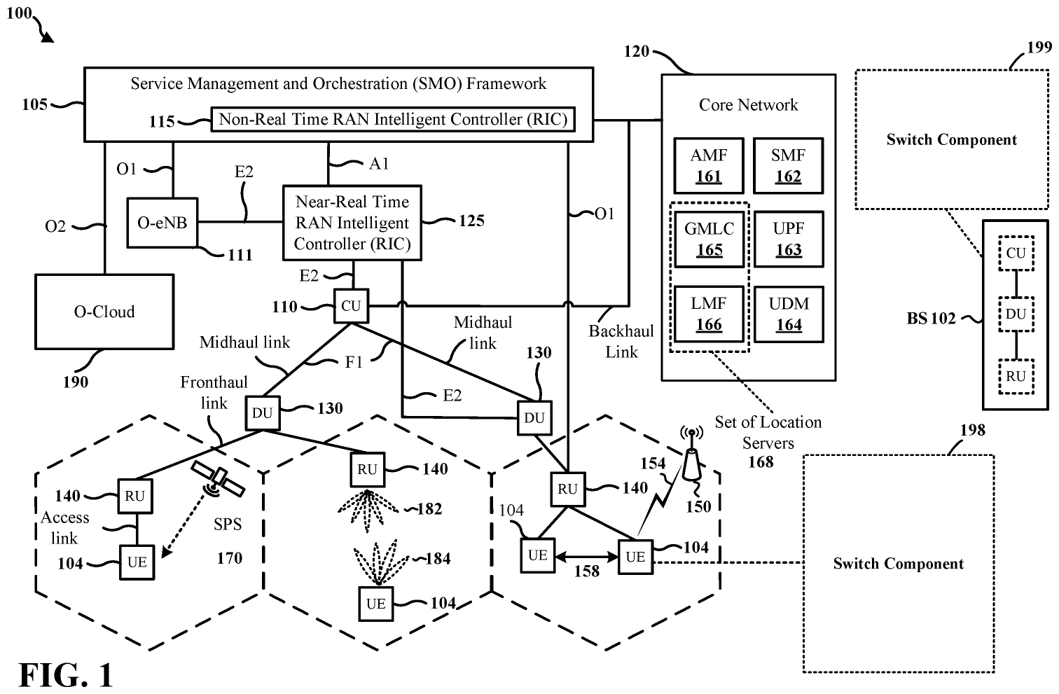

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit—User Plane (CU-UP)), control plane functionality (i.e., Central Unit—Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 600, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 902.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (610 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may comprise a switch component 198 configured to predict a blockage condition to a first beam communicating with a network node; and transmit, to the network node, a beam switch indication indicating a scheduled change in a TCI state mapped from the first beam to a second beam in response to the predicted blockage condition.

Referring again to FIG. 1, in certain aspects, the base station 102 may comprise a switch component 199 configured to communicate with a UE using a first beam; and obtain a beam switch indication comprising a scheduled change in a TCI state mapped from the first beam to a second beam for the UE based on a predicted blockage condition to the first beam.

Although the following description may be focused on 5G NR, the concepts described herein may be applicable to other similar areas, such as LTE, LTE-A, CDMA, GSM, and other wireless technologies.

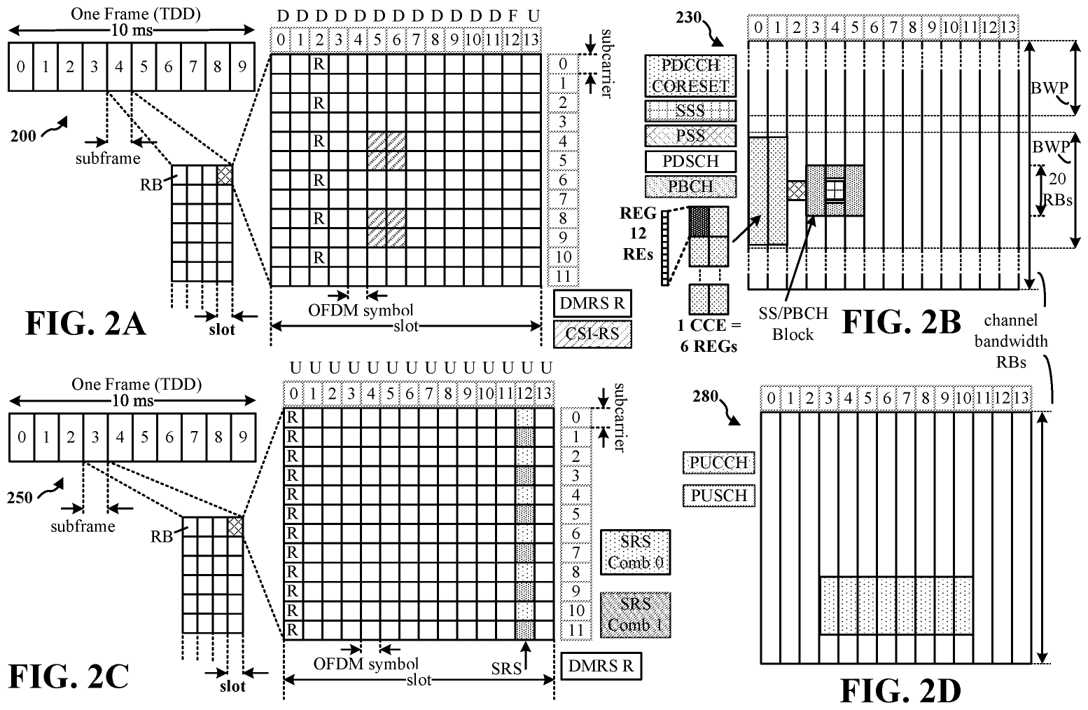

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

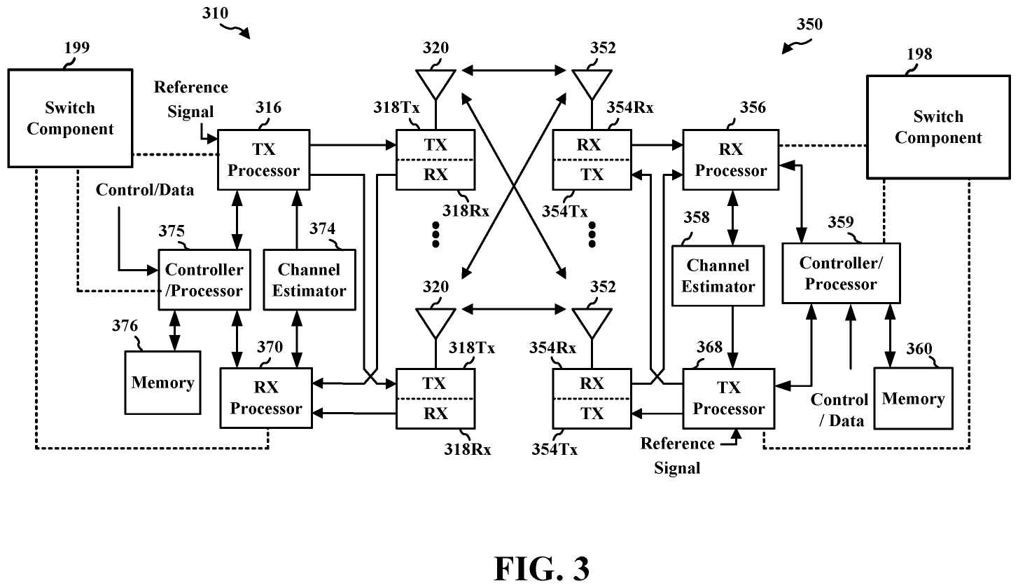

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially pre-coded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the switch component 198 of FIG. 1.

At least one of the TX processor 316, the RX processor 370, and the controller/processor 375 may be configured to perform aspects in connection with the switch component 199 of FIG. 1.

In wireless communications, multi-antenna beamforming is commonly used in frequency range 2 (FR2) or millimeter wave systems. Blockage may be a serious detriment to link performance in FR2 systems. Blockage may also play a serious role in systems beyond FR2 (e.g., FR4/5). Blockage may occur due to users using a UE, such as hand, fingers, head, or other body parts, that may cause blockage while the UE is being used. Blockage may also occur due to external objects, such as other people, vehicles, buildings, foliage, terrain, etc. The onset of blockage may be relatively slow or fast, where time-scales of change being on the order of a few 10s to 100s of ms. Blockage may degrade the link performance (e.g., by 2-40 dB) based on blockage mode, where some models assume a flat 30 dB loss over the coverage region of blockage.

Link degradation time is defined as the time taken for RSSI/RSRP to drop from its steady state value to its minima or loss of link, whichever comes earlier. In some instances, a behavior of RSSI/RSRP degradation with blockage may include time-scales of change which may be slow (e.g., a few 100 ms for RSSI to drop significantly).

Adaptive/dynamic beam weights may be considered to combat blockage. For adaptive beam weights, a consideration of the performance of beam refinement at a receiver node only may be compared to beam refinements at both the transmitter and receiver nodes. Refinement at the transmitter may be based on an addition of the two best narrow beams from a size-32 codebook for an 8×4 array, while refinement at the receiver may be based on a per antenna co-phasing for a 4×1 array to generate good beamforming structures.

Aspects presented herein provide a configuration for a UE to request a TCI state switch for blockage conditions. The aspects presented herein allow for a UE to predict a blockage condition to a beam used for communicating with a network node, such that the UE may schedule a beam switch at the UE based on the predicted blockage condition. At least one advantage of the disclosure is that since hand movements of users using a UE may be predicted in advance (e.g., in a gaming mode or in a voice call), due in part to usage of the UE, the UE may utilize different UE side beam weights based on the predicted hand movements in an effort to optimize performance. Associated with any beam change at the UE side is a corresponding beam change at the network node. The UE may determine such a UE side beam change, correlated with a TCI state change, and signal such a change to the network node.

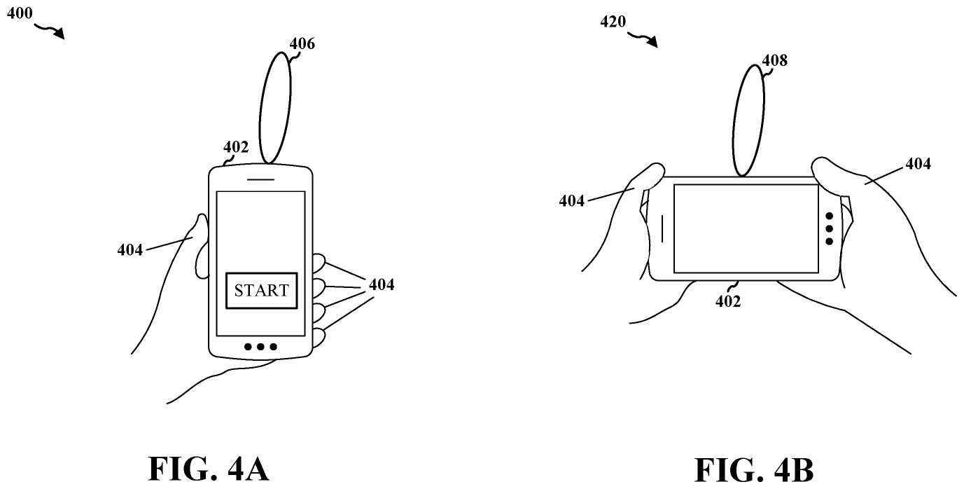

Hand or body movements are physical movements, where time-scales of change can be 10s to 100s of ms. In some aspects, finger, hand, or body movements of a user using a UE may be predicted ahead of time (e.g., gaming scenarios, voice call, etc.). For example, as shown in diagram 400 of FIG. 4A, a UE 402 may be held within the hand of the user and supported by the fingers 404, where the beam 406 may communicate with the network node. The user may initiate an application on the UE, such that the orientation of the UE is changed. With reference to diagram 420 of FIG. 4B, the user may rotate the UE 402 and hold the UE using both hands and fingers 404 in response to initiating the application on the UE. In such instances, a second beam 408 of the UE may be utilized to communicate with the network node. The beam 406 of the UE 402 may be blocked by the hands or fingers 404 of the user while the UE 402 is repositioned in response to the initiation of the application. An approach to predict hand movements may be based on ML/AI correlating past observations for future predictions.

Different hand movements may be associated with different UE side beam weights for optimal performance. Optimal beam weights may depend on a user's hand grip, air gaps between the user's fingers, skin properties, fat/water content of skin/body, etc. for a part of the user's body that is affecting a beam direction. Optimal beam weights may be a beyond-static codebook solution exploring the space of all possible phase shifter and amplitude control possibilities. Note that due to radio frequency integrated circuit (RFIC) memory constraints, hybrid/analog beamforming codebooks used at the UE typically come from a fixed/static codebook of beam weights. The optimal beam weights are not constrained by RFIC memory requirements and can be general phase shifter and/or amplitude control combinations. For better performance, the UE may choose to change beams based on changes in a blockage condition. As the UE may predict the blockage condition with a threshold level of accuracy, the UE may schedule beam changes based on such predictions.

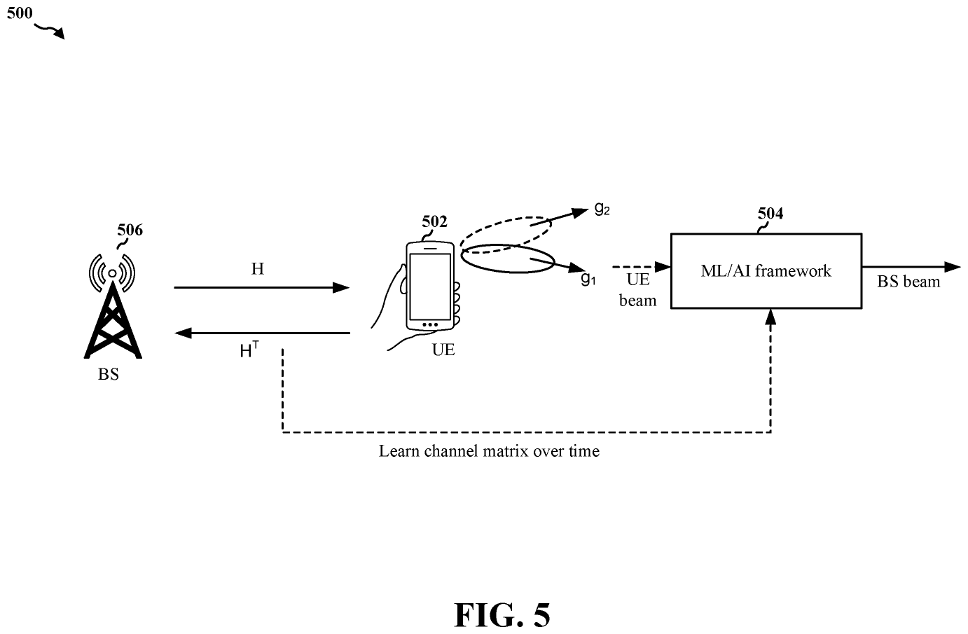

In some aspects, the prediction of the blockage condition may be based on ML or AI. FIG. 5 provides an example of a diagram 500 of a UE 502 communicating with an AI/ML framework 504. Given a channel matrix H between the base station 506 and the UE 502, if f is the chosen beam at base station, an optimal beam for SNR maximization on downlink is Hf at the UE, which may be called the matched filter structure. Extending this logic to uplink transmissions, if the UE changes beam from g₁ to g₂, then the optimal beam at the base station changes from H^{T}g₁ to H^{T}g₂. As the UE changes its beam in response to a predicted blockage condition, it would be advantageous if the base station were to also switch its beam in accordance with the beam switch at the UE for optimal performance. The ML/AI framework 504 may learn/track the channel matrix between the base station and the UE over time and may be based on explicit or implicit learning of H, knowledge of the UE beam change, and mapping the two to a corresponding TCI state change. In some aspects, the UE may be configured to request a TCI state change to the base station associated with predicted time-scales at which such a TCI state change may occur.

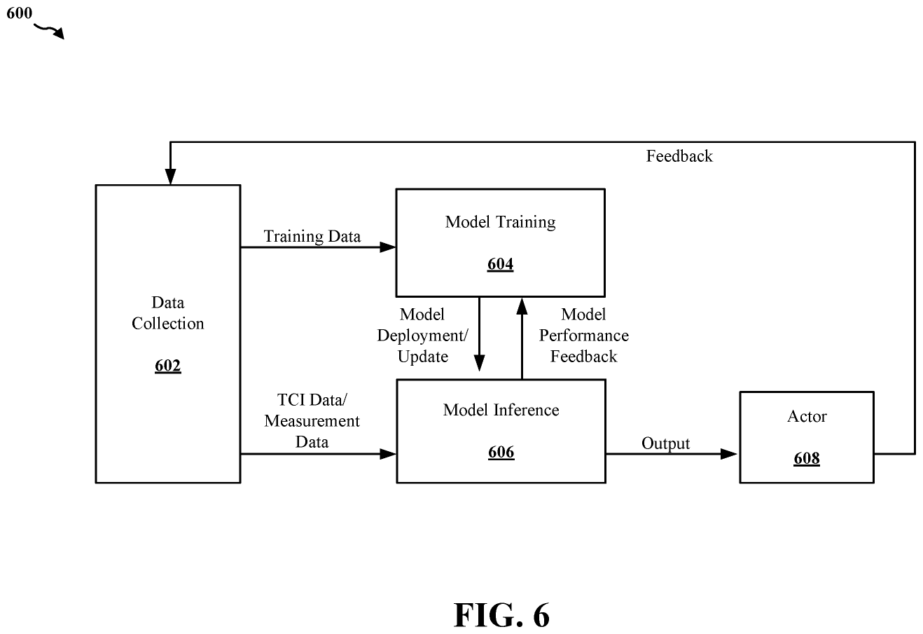

FIG. 6 an example of the AI/ML algorithm 600 that may be used in connection with wireless communication. The AI/ML algorithm 600 may include various functions including a data collection 602, a model training function 604, a model inference function 606, and an actor 608.

The data collection 602 may be a function that provides input data to the model training function 604 and the model inference function 606. The data collection 602 function may include any form of data preparation, and it may not be specific to the implementation of the AI/ML algorithm (e.g., data pre-processing and cleaning, formatting, and transformation). The examples of input data may include, but not limited to, channel matrix measurements, from UEs or network nodes, feedback from the actor 608, output from another AI/ML model. The data collection 602 may include training data, which refers to the data to be sent as the input for the AI/ML model training function 604, and inference data, which refers to be sent as the input for the AI/ML model inference function 606.

The model training function 604 may be a function that performs the ML model training, validation, and testing, which may generate model performance metrics as part of the model testing procedure. The model training function 604 may also be responsible for data preparation (e.g. data pre-processing and cleaning, formatting, and transformation) based on the training data delivered or received from the data collection 602 function. The model training function 604 may deploy or update a trained, validated, and tested AI/ML model to the model inference function 606, and receive a model performance feedback from the model inference function 606.

The model inference function 606 may be a function that provides the AI/ML model inference output (e.g., predictions or decisions). The model inference function 606 may also perform data preparation (e.g., data pre-processing and cleaning, formatting, and transformation) based on the inference data delivered from the data collection 602 function. The output of the model inference function 606 may include the inference output of the AI/ML model produced by the model inference function 606. The details of the inference output may be use-case specific. As an example, the output may include an estimated channel matrix over time.

The model performance feedback may refer to information derived from the model inference function 606 that may be suitable for improvement of the AI/ML model trained in the model training function 604. The feedback from the actor 608 or other network entities (via the data collection 602 function) may be implemented for the model inference function 606 to create the model performance feedback.

The actor 608 may be a function that receives the output from the model inference function 606 and triggers or performs corresponding actions. The actor may trigger actions directed to network entities including the other network entities or itself. The actor 608 may also provide a feedback information that the model training function 604 or the model interference function 606 to derive training or inference data or performance feedback. The feedback may be transmitted back to the data collection 602.

The network may use machine-learning algorithms, deep-learning algorithms, neural networks, reinforcement learning, regression, boosting, or advanced signal processing methods for aspects of wireless communication including the identification of neighbor TCI candidates for autonomous TCI candidate set updates based on DCI selection of a TCI state.

In some aspects described herein, the network may train one or more neural networks to learn dependence of measured qualities on individual parameters. Among others, examples of machine learning models or neural networks that may be comprised in the network entity include artificial neural networks (ANN); decision tree learning; convolutional neural networks (CNNs); deep learning architectures in which an output of a first layer of neurons becomes an input to a second layer of neurons, and so forth; support vector machines (SVM), e.g., including a separating hyperplane (e.g., decision boundary) that categorizes data; regression analysis; bayesian networks; genetic algorithms; Deep convolutional networks (DCNs) configured with additional pooling and normalization layers; and Deep belief networks (DBNs).

A machine learning model, such as an artificial neural network (ANN), may include an interconnected group of artificial neurons (e.g., neuron models), and may be a computational device or may represent a method to be performed by a computational device. The connections of the neuron models may be modeled as weights. Machine learning models may provide predictive modeling, adaptive control, and other applications through training via a dataset. The model may be adaptive based on external or internal information that is processed by the machine learning model. Machine learning may provide non-linear statistical data model or decision making and may model complex relationships between input data and output information.

A machine learning model may include multiple layers and/or operations that may be formed by concatenation of one or more of the referenced operations. Examples of operations that may be involved include extraction of various features of data, convolution operations, fully connected operations that may be activated or deactivates, compression, decompression, quantization, flattening, etc. As used herein, a “layer” of a machine learning model may be used to denote an operation on input data. For example, a convolution layer, a fully connected layer, and/or the like may be used to refer to associated operations on data that is input into a layer. A convolution A×B operation refers to an operation that converts a number of input features A into a number of output features B. “Kernel size” may refer to a number of adjacent coefficients that are combined in a dimension. As used herein, “weight” may be used to denote one or more coefficients used in the operations in the layers for combining various rows and/or columns of input data. For example, a fully connected layer operation may have an output y that is determined based at least in part on a sum of a product of input matrix x and weights A (which may be a matrix) and bias values B (which may be a matrix). The term “weights” may be used herein to generically refer to both weights and bias values. Weights and biases are examples of parameters of a trained machine learning model. Different layers of a machine learning model may be trained separately.

Machine learning models may include a variety of connectivity patterns, e.g., including any of feed-forward networks, hierarchical layers, recurrent architectures, feedback connections, etc. The connections between layers of a neural network may be fully connected or locally connected. In a fully connected network, a neuron in a first layer may communicate its output to each neuron in a second layer, and each neuron in the second layer may receive input from every neuron in the first layer. In a locally connected network, a neuron in a first layer may be connected to a limited number of neurons in the second layer. In some aspects, a convolutional network may be locally connected and configured with shared connection strengths associated with the inputs for each neuron in the second layer. A locally connected layer of a network may be configured such that each neuron in a layer has the same, or similar, connectivity pattern, but with different connection strengths.

A machine learning model or neural network may be trained. For example, a machine learning model may be trained based on supervised learning. During training, the machine learning model may be presented with input that the model uses to compute to produce an output. The actual output may be compared to a target output, and the difference may be used to adjust parameters (such as weights and biases) of the machine learning model in order to provide an output closer to the target output. Before training, the output may be incorrect or less accurate, and an error, or difference, may be calculated between the actual output and the target output. The weights of the machine learning model may then be adjusted so that the output is more closely aligned with the target. To adjust the weights, a learning algorithm may compute a gradient vector for the weights. The gradient may indicate an amount that an error would increase or decrease if the weight were adjusted slightly. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted so as to reduce the error or to move the output closer to the target. This manner of adjusting the weights may be referred to as back propagation through the neural network. The process may continue until an achievable error rate stops decreasing or until the error rate has reached a target level.

The machine learning models may include computational complexity and substantial processor for training the machine learning model. An output of one node is connected as the input to another node. Connections between nodes may be referred to as edges, and weights may be applied to the connections/edges to adjust the output from one node that is applied as input to another node. Nodes may apply thresholds in order to determine whether, or when, to provide output to a connected node. The output of each node may be calculated as a non-linear function of a sum of the inputs to the node. The neural network may include any number of nodes and any type of connections between nodes. The neural network may include one or more hidden nodes. Nodes may be aggregated into layers, and different layers of the neural network may perform different kinds of transformations on the input. A signal may travel from input at a first layer through the multiple layers of the neural network to output at a last layer of the neural network and may traverse layers multiple times.

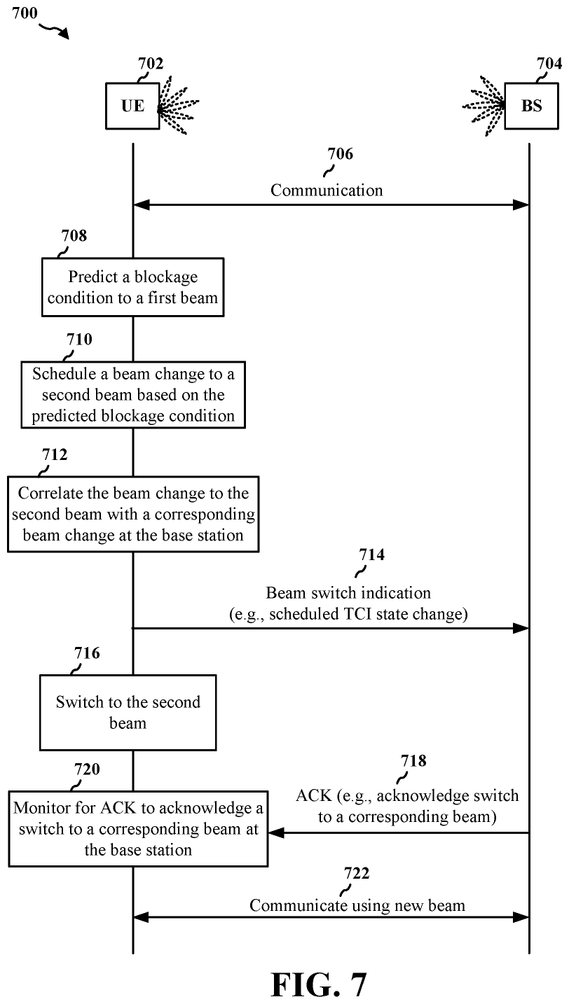

FIG. 7 is a call flow diagram 700 of signaling between a UE 702 and a base station 704. Although the example aspects are described for a base station 704, one or more of the aspects may be performed by a base station in aggregated form or by a component of a disaggregated base station, such as a CU, DU or RU. The base station 704 may be configured to provide at least one cell. The UE 702 may be configured to communicate with the base station 704. For example, in the context of FIG. 1, the base station 704 may correspond to base station 102, 310, and/or 506. Further, a UE 702 may correspond to at least UE 104, 350, 402, and/or UE 502.

At 706, the base station 704 and UE 702 may be communicating with each other. The base station 704 may communicate with the UE 702 using a first beam. The UE 702 may use a first beam to communicate with the base station 704.

At 708, the UE may predict a blockage condition to the first beam communicating with the base station 704, which the UE may indicate to the network. The prediction may be based on any of the aspects described in connection with FIGS. 4A-6. In some aspects, the beam switch indication may indicate a corresponding beam at the base station 704 that corresponds with the second beam of the UE 702. The corresponding beam at the base station may be determined based on a correlation between a beam change at the UE and the corresponding beam at the base station. In some aspects, the blockage condition may be based on at least physical movements of a user using the UE or of the UE. For example, a user's finger, hand, or body part may change position during the course of using the UE, such that a repositioning of the user's finger, hand, or body part may cause the blockage condition, e.g., as described in connection with FIGS. 4A and 4B.

At 710, the UE 702 may schedule a beam change to a second beam based on the predicted blockage condition. The UE may select the second beam from a set of beams based on the predicted blockage condition. For example, some beams may perform differently under different blockage conditions, such that the UE selects the beam that performs optimally under the predicted blockage condition

At 712, the UE 702 may correlate a beam change to the second beam at the UE with a corresponding beam change at the base station 704. A correlation between the second beam at the UE and the corresponding beam change at the base station may be based on an observation of communication between the UE and the base station to estimate a channel matrix between the UE and the network node. In some aspects, a correlation between the second beam at the UE and the corresponding beam change at the base station may be based on a machine learning (ML) or artificial intelligence (AI) framework, e.g., which may include any of the aspects described in connection with FIG. 5 and/or FIG. 6. The ML or AI framework may utilize prior observations of communications between the UE and the base station to predict the blockage condition. In some aspects, the ML or AI framework and associated optimizations are performed at the UE. In some aspects, the ML or AI framework and associated optimizations are performed within a second network node in communication with the UE.

At 714, the UE 702 may transmit a beam switch indication. The UE may transmit the beam switch indication to the base station 704. The base station 704 may receive the beam switch indication from the UE 702. The beam switch indication may indicate a scheduled change in a TCI state mapped from the first beam to a second beam in response to the predicted blockage condition. In some aspects, the beam switch indication may comprise a request to switch beams to a corresponding beam at the base station associated with a predicted time scale. The predicted time scale may correspond with a start time of the predicted blockage condition. The predicted time scale may account for the switch time at the base station to switch beams in an effort to correspond with the beam switch at the UE.

At 716, the UE 702 may switch to the second beam. The UE may switch to the second beam in response to transmitting the beam switch indication.

At 718, the base station 704 may output an ACK. The base station 704 may output the ACK to the UE 702. The UE 702 may receive the ACK from the base station 704. The base station may output the ACK acknowledging a switch to a corresponding beam that corresponds with the second beam at the UE.

At 720, the UE 702 may monitor for an ACK from the base station 704. The UE may monitor for the ACK from the base station to acknowledge a switch to a corresponding beam at the network node. Then, at 722, the UE and/or the base station may transmit and/or receive communication based on the second beam. In some aspects, the UE may continue to communicate with the network node using the second beam regardless if the UE receives the ACK or not from the network node.

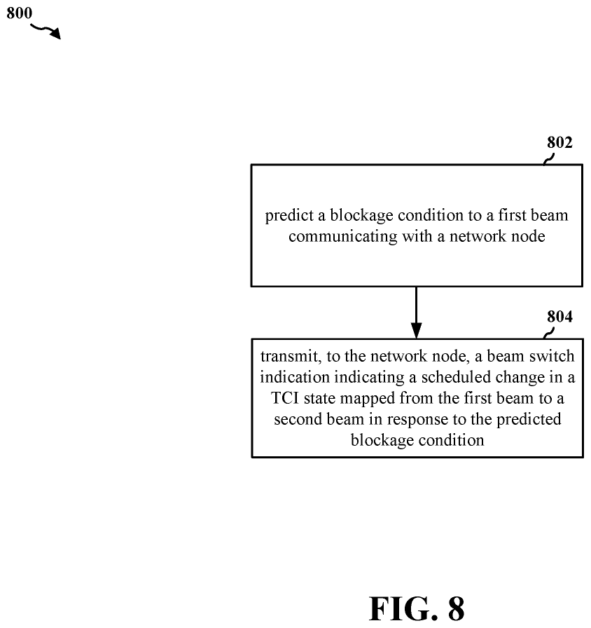

FIG. 8 is a flowchart 800 of a method of wireless communication. The method may be performed by a UE (e.g., the UE 104; the apparatus 1004). One or more of the illustrated operations may be omitted, transposed, or contemporaneous. The method may allow a UE to determine a TCI state change at the UE based on a predicted blockage condition.

At 802, the UE may predict a blockage condition to a first beam. For example, 802 may be performed by switch component 198 of apparatus 1004. The UE may predict the blockage condition to the first beam communicating with a network node. In some aspects, the beam switch indication may indicate a corresponding beam at the network node that corresponds with the second beam of the UE. the corresponding beam at the network node may be determined based on a correlation between a beam change at the UE and the corresponding beam at the network node. In some aspects, the blockage condition may be based on at least physical movements of a user using the UE or of the UE. For example, a user's finger, hand, or body part may change position during the course of using the UE, such that a repositioning of the user's finger, hand, or body part may cause the blockage condition. Example aspects of a blockage are described in connection with FIG. 4A and 4B. The prediction may be based on any of the aspects described in connection with FIGS. 5-7.

At 804, the UE may transmit a beam switch indication. For example, 804 may be performed by switch component 198 of apparatus 1004. The UE may transmit the beam switch indication to the network node. The beam switch indication may indicate a scheduled change in a TCI state mapped from the first beam to a second beam in response to the predicted blockage condition. In some aspects, the beam switch indication may comprise a request to switch beams to a corresponding beam at the network node associated with a predicted time scale. The predicted time scale may correspond with a start time of the predicted blockage condition. The predicted time scale may account for the switch time at the network node to switch beams in an effort to correspond with the beam switch at the UE. FIG. 7 illustrates an example of a UE transmitting a beam switch indication.

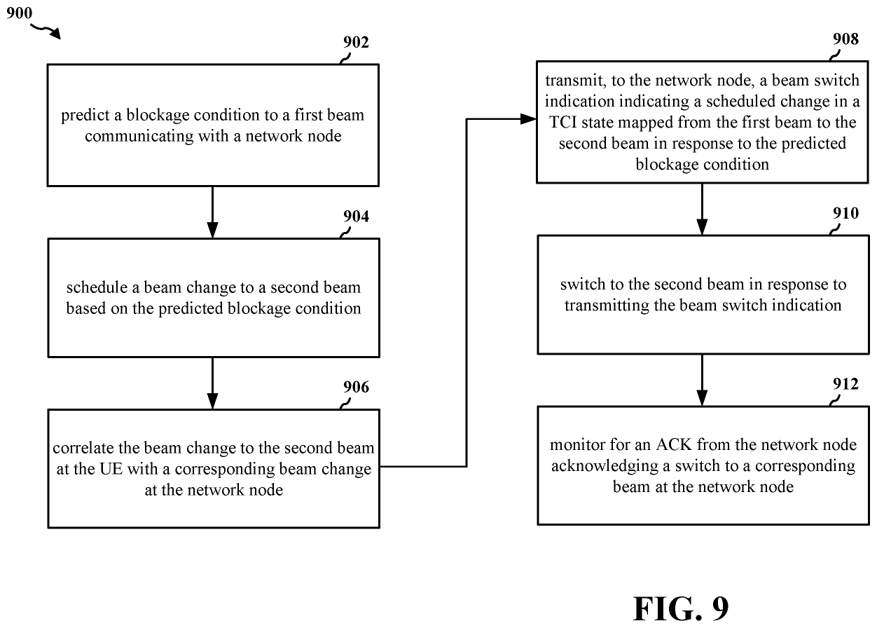

FIG. 9 is a flowchart 900 of a method of wireless communication. The method may be performed by a UE (e.g., the UE 104; the apparatus 1004). One or more of the illustrated operations may be omitted, transposed, or contemporaneous. The method may allow a UE to determine a TCI state change at the UE based on a predicted blockage condition.

At 902, the UE may predict a blockage condition to a first beam. For example, 902 may be performed by switch component 198 of apparatus 1004. The UE may predict the blockage condition to the first beam communicating with a network node. In some aspects, the beam switch indication may indicate a corresponding beam at the network node that corresponds with the second beam of the UE. The corresponding beam at the network node may be determined based on a correlation between a beam change at the UE and the corresponding beam at the network node. In some aspects, the blockage condition may be based on at least physical movements of a user using the UE or of the UE. For example, a user's finger, hand, or body part may change position during the course of using the UE, such that a repositioning of the user's finger, hand, or body part may cause the blockage condition. Example aspects of a blockage are described in connection with FIG. 4A and 4B. The prediction may be based on any of the aspects described in connection with FIGS. 5-7.

At 904, the UE may schedule a beam change to a second beam. For example, 904 may be performed by switch component 198 of apparatus 1004. The UE may schedule the beam change to the second beam based on the predicted blockage condition. The UE may select the second beam from a set of beams based on the predicted blockage condition. For example, some beams may perform differently under different blockage conditions, such that the UE selects the beam that performs optimally under the predicted blockage condition. FIG. 7 illustrates example aspects of a UE scheduling a beam change.

At 906, the UE may correlate a beam change to the second beam at the UE with a corresponding beam change at the network node. For example, 906 may be performed by switch component 198 of apparatus 1004. A correlation between the second beam at the UE and the corresponding beam change at the network node may be based on an observation of communication between the UE and the network node to estimate a channel matrix between the UE and the network node. In some aspects, a correlation between the second beam at the UE and the corresponding beam change at the network node may be based on a ML or AI framework. The ML or AI framework may utilize prior observations of communications between the UE and the network node to predict the blockage condition. In some aspects, the ML or AI framework and associated optimizations are performed at the UE. In some aspects, the ML or AI framework and associated optimizations are performed within a second network node in communication with the UE. FIGS. 5 and 7 illustrates example aspects of a UE correlating the beams.

At 908, the UE may transmit a beam switch indication. For example, 908 may be performed by switch component 198 of apparatus 1004. The UE may transmit the beam switch indication to the network node. The beam switch indication may indicate a scheduled change in a TCI state mapped from the first beam to a second beam in response to the predicted blockage condition. In some aspects, the beam switch indication may comprise a request to switch beams to a corresponding beam at the network node associated with a predicted time scale. The predicted time scale may correspond with a start time of the predicted blockage condition. The predicted time scale may account for the switch time at the network node to switch beams in an effort to correspond with the beam switch at the UE. FIG. 7 illustrates an example of a UE transmitting a beam switch indication.

At 910, the UE may switch to the second beam. For example, 910 may be performed by switch component 198 of apparatus 1004. The UE may switch to the second beam in response to transmitting the beam switch indication. FIG. 7 illustrates an example of the UE switching to a different beam.

At 912, the UE may monitor for an ACK from the network node. For example, 912 may be performed by switch component 198 of apparatus 1004. The UE may monitor for the ACK from the network node to acknowledge a switch to a corresponding beam at the network node. The UE may continue to communicate with the network node using the second beam regardless if the UE receives the ACK or not from the network node. FIG. 7 illustrates an example of a UE monitoring for an ACK.

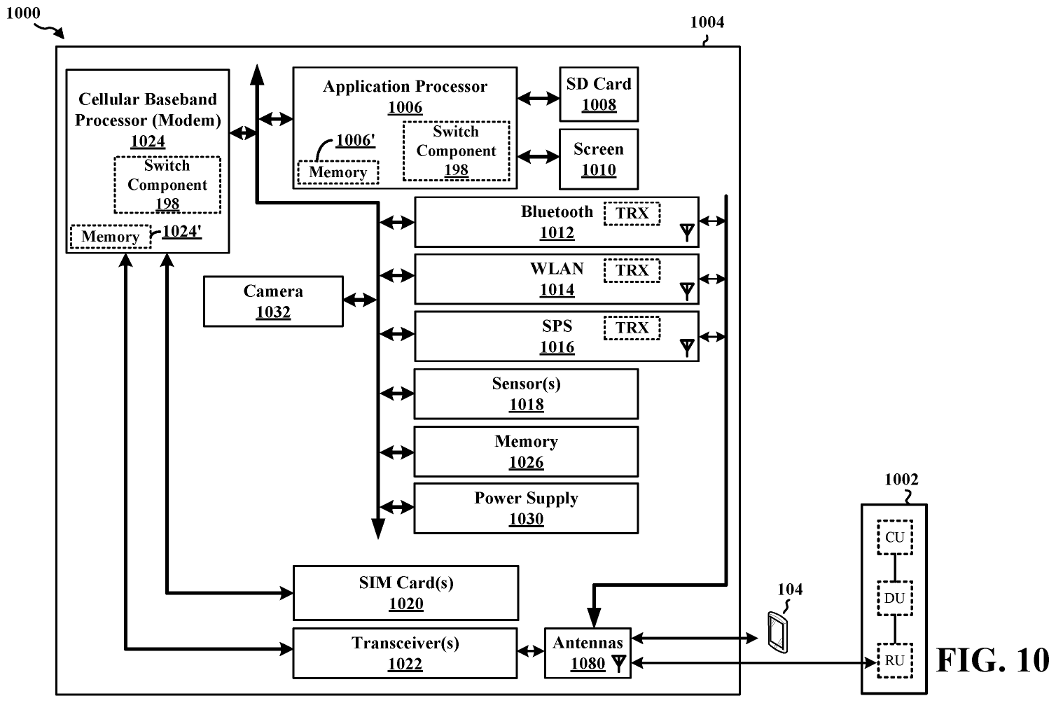

FIG. 10 is a diagram 1000 illustrating an example of a hardware implementation for an apparatus 1004. The apparatus 1004 may be a UE, a component of a UE, or may implement UE functionality. In some aspects, the apparatus 904 may include a cellular baseband processor 1024 (also referred to as a modem) coupled to one or more transceivers 1022 (e.g., cellular RF transceiver). The cellular baseband processor 1024 may include on-chip memory 1024′. In some aspects, the apparatus 1004 may further include one or more subscriber identity modules (SIM) cards 1020 and an application processor 1006 coupled to a secure digital (SD) card 1008 and a screen 1010. The application processor 1006 may include on-chip memory 1006′. In some aspects, the apparatus 1004 may further include a Bluetooth module 1012, a WLAN module 1014, an SPS module 1016 (e.g., GNSS module), one or more sensor modules 1018 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1026, a power supply 1030, and/or a camera 1032. The Bluetooth module 1012, the WLAN module 1014, and the SPS module 1016 may include an on-chip transceiver (TRX) (or in some cases, just a receiver (RX)). The Bluetooth module 1012, the WLAN module 1014, and the SPS module 1016 may include their own dedicated antennas and/or utilize the antennas 1080 for communication. The cellular baseband processor 1024 communicates through the transceiver(s) 1022 via one or more antennas 1080 with the UE 104 and/or with an RU associated with a network node 1002. The cellular baseband processor 1024 and the application processor 1006 may each include a computer-readable medium/memory 1024′, 1006′, respectively. The additional memory modules 1026 may also be considered a computer-readable medium/memory. Each computer-readable medium/memory 1024′, 1006′, 1026 may be non-transitory. The cellular baseband processor 1024 and the application processor 1006 are each responsible for general processing, including the execution of software stored on the computer-readable medium/memory. The software, when executed by the cellular baseband processor 1024/application processor 1006, causes the cellular baseband processor 1024/application processor 1006 to perform the various functions described supra. The computer-readable medium/memory may also be used for storing data that is manipulated by the cellular baseband processor 1024/application processor 1006 when executing software. The cellular baseband processor 1024/application processor 1006 may be a component of the UE 350 and may include the memory 360 and/or at least one of the TX processor 368, the RX processor 356, and the controller/processor 359. In one configuration, the apparatus 1004 may be a processor chip (modem and/or application) and include just the cellular baseband processor 1024 and/or the application processor 1006, and in another configuration, the apparatus 1004 may be the entire UE (e.g., see 350 of FIG. 3) and include the additional modules of the apparatus 1004.

As discussed supra, the component 198 is configured to predict a blockage condition to a first beam communicating with a network node; and transmit, to the network node, a beam switch indication indicating a scheduled change in a TCI state mapped from the first beam to a second beam in response to the predicted blockage condition. The component 198 may be further configured to perform any of the aspects described in connection with the flowchart in FIG. 8 or 9, or performed by the UE in the communication flow in FIG. 7 and/or the UE in FIG. 5. The component 198 may be within the cellular baseband processor 1024, the application processor 1006, or both the cellular baseband processor 1024 and the application processor 1006. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1004 may include a variety of components configured for various functions. In one configuration, the apparatus 1004, and in particular the cellular baseband processor 1024 and/or the application processor 1006, includes means for predicting a blockage condition to a first beam communicating with a network node. The apparatus includes means for transmitting, to the network node, a beam switch indication indicating a scheduled change in a TCI state mapped from the first beam to a second beam in response to the predicted blockage condition. The apparatus further includes means for correlating a beam change to the second beam at the UE with a corresponding beam change at the network node. The apparatus further includes means for scheduling a beam change to the second beam based on the predicted blockage condition. The apparatus further includes means for switching to the second beam in response to transmitting the beam switch indication. The apparatus further includes means for monitoring for an ACK from the network node acknowledging a switch to a corresponding beam at the network node. The apparatus may further include means configured to perform any of the aspects described in connection with the flowchart in FIG. 8 or 9, or performed by the UE in the communication flow in FIG. 7 and/or the UE in FIG. 5. The means may be the component 198 of the apparatus 1004 configured to perform the functions recited by the means. As described supra, the apparatus 1004 may include the TX processor 368, the RX processor 356, and the controller/processor 359. As such, in one configuration, the means may be the TX processor 368, the RX processor 356, and/or the controller/processor 359 configured to perform the functions recited by the means.

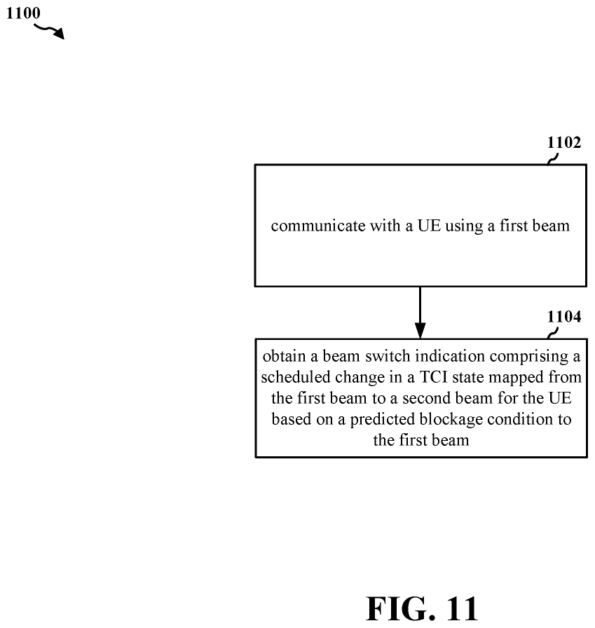

FIG. 11 is a flowchart 1100 of a method of wireless communication. The method may be performed by a base station (e.g., the base station 102; the network node 1302. One or more of the illustrated operations may be omitted, transposed, or contemporaneous. The method may allow a network node to receive a TCI state change at a UE based on a predicted blockage condition at the UE.

At 1102, the network node may communicate with a UE. For example, 1102 may be performed by switch component 199 of network node 1302. The network node may communicate with the UE using a first beam. FIG. 7 illustrates an example of a network node communicating with a UE.

At 1104, the network node may obtain a beam switch indication comprising a scheduled change in a TCI state mapped from the first beam to a second beam for the UE based on a predicted blockage condition to the first beam. For example, 1104 may be performed by switch component 199 of network node 1302. In some aspects, the beam switch indication may indicate a corresponding beam at the network node that corresponds with the second beam of the UE. In some aspects, a corresponding beam at the network node may be determined based on a correlation between the second beam at the UE and a corresponding beam at the network node that corresponds with the second beam at the UE. In some aspects, the beam switch indication may comprise a request to switch beams to a corresponding beam at the network node associated with a predicted time scale. The predicted time scale may correspond with a start time of the predicted blockage condition. FIG. 7 illustrates an example of the network node receiving a beam switch indication from a UE.

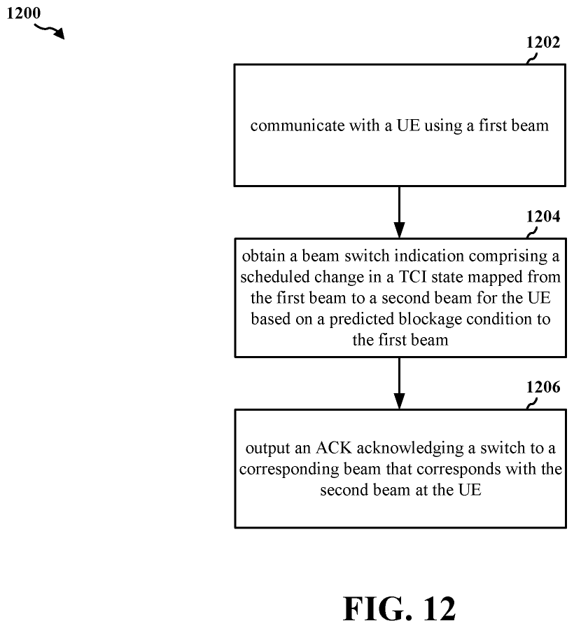

FIG. 12 is a flowchart 1200 of a method of wireless communication. The method may be performed by a base station (e.g., the base station 102; the network node 1302. One or more of the illustrated operations may be omitted, transposed, or contemporaneous. The method may allow a network node to receive a TCI state change at a UE based on a predicted blockage condition at the UE.

At 1202, the network node may communicate with a UE. For example, 1202 may be performed by switch component 199 of network node 1302. The network node may communicate with the UE using a first beam. FIG. 7 illustrates an example of a network node communicating with a UE.

At 1204, the network node may obtain a beam switch indication comprising a scheduled change in a TCI state mapped from the first beam to a second beam for the UE based on a predicted blockage condition to the first beam. For example, 1204 may be performed by switch component 199 of network node 1302. In some aspects, the beam switch indication may indicate a corresponding beam at the network node that corresponds with the second beam of the UE. In some aspects, a corresponding beam at the network node may be determined based on a correlation between the second beam at the UE and a corresponding beam at the network node that corresponds with the second beam at the UE. In some aspects, the beam switch indication may comprise a request to switch beams to a corresponding beam at the network node associated with a predicted time scale. The predicted time scale may correspond with a start time of the predicted blockage condition. FIG. 7 illustrates an example of the network node receiving a beam switch indication from a UE.

At 1206, the network node may output an ACK. For example, 1206 may be performed by switch component 199 of network node 1302. The network node may output the ACK to the UE. The network node may output the ACK acknowledging a switch to a corresponding beam that corresponds with the second beam at the UE. FIG. 7 illustrates an example of the network node outputting an ACK to the UE to acknowledge a switch to a corresponding beam that corresponds with the second beam at the UE.

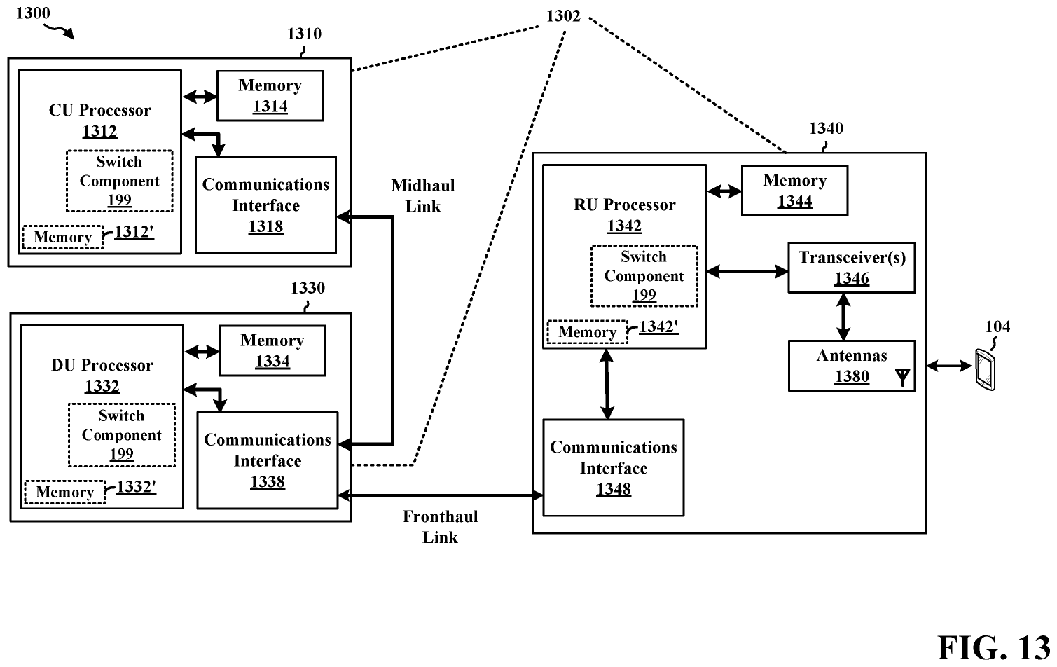

FIG. 13 is a diagram 1300 illustrating an example of a hardware implementation for a network node 1302. The network node 1302 may be a BS, a component of a BS, or may implement BS functionality. The network node 1302 may include at least one of a CU 1310, a DU 1330, or an RU 1340. For example, depending on the layer functionality handled by the component 199, the network node 1302 may include the CU 1310; both the CU 1310 and the DU 1330; each of the CU 1310, the DU 1330, and the RU 1340; the DU 1330; both the DU 1330 and the RU 1340; or the RU 1340. The CU 1310 may include a CU processor 1312. The CU processor 1312 may include on-chip memory 1312′. In some aspects, the CU 1310 may further include additional memory modules 1314 and a communications interface 1318. The CU 1310 communicates with the DU 1330 through a midhaul link, such as an F1 interface. The DU 1330 may include a DU processor 1332. The DU processor 1332 may include on-chip memory 1332′. In some aspects, the DU 1330 may further include additional memory modules 1334 and a communications interface 1338. The DU 1330 communicates with the RU 1340 through a fronthaul link. The RU 1340 may include an RU processor 1342. The RU processor 1342 may include on-chip memory 1342′. In some aspects, the RU 1340 may further include additional memory modules 1344, one or more transceivers 1346, antennas 1380, and a communications interface 1348. The RU 1340 communicates with the UE 104. The on-chip memory 1312′, 1332′, 1342′ and the additional memory modules 1314, 1334, 1344 may each be considered a computer-readable medium/memory. Each computer-readable medium/memory may be non-transitory. Each of the processors 1312, 1332, 1342 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 is configured to communicate with a UE using a first beam; and obtain a beam switch indication comprising a scheduled change in a TCI state mapped from the first beam to a second beam for the UE based on a predicted blockage condition to the first beam. The component 199 may be further configured to perform any of the aspects described in connection with the flowchart in FIG. 11 or 12, or performed by the base station in the communication flow in FIG. 7 and/or the base station in FIG. 5. The component 199 may be within one or more processors of one or more of the CU 1310, DU 1330, and the RU 1340. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network node 1302 may include a variety of components configured for various functions. In one configuration, the network node 1302 includes means for communicating with a UE using a first beam. The network node includes means for obtaining a beam switch indication comprising a scheduled change in a TCI state mapped from the first beam to a second beam for the UE based on a predicted blockage condition to the first beam. The network node further includes means for outputting an ACK acknowledging a switch to a corresponding beam that corresponds with the second beam at the UE. The network node may further include means configured to perform any of the aspects described in connection with the flowchart in FIG. 11 or 12, or performed by the base station in the communication flow in FIG. 7 and/or the base station in FIG. 5. The means may be the component 199 of the network node 1302 configured to perform the functions recited by the means. As described supra, the network node 1302 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of wireless communication at a UE comprising predicting a blockage condition to a first beam communicating with a network node; and transmitting, to the network node, a beam switch indication indicating a scheduled change in a transmission configuration indicator (TCI) state mapped from the first beam to a second beam in response to the predicted blockage condition.
Aspect 2 is the method of aspect 1, further includes that the beam switch indication indicates a corresponding beam at the network node that corresponds with the second beam of the UE.
Aspect 3 is the method of any of aspects 1 and 2, further including correlating a beam change to the second beam at the UE with a corresponding beam change at the network node.
Aspect 4 is the method of any of aspects 1-3, further includes that a correlation between the second beam at the UE and the corresponding beam change at the network node is based on an observation of communication between the UE and the network node to estimate a channel matrix between the UE and the network node.
Aspect 5 is the method of any of aspects 1-4, further includes that a correlation between the second beam at the UE and the corresponding beam change at the network node is based on a ML or AI framework.
Aspect 6 is the method of any of aspects 1-5, further includes that the ML or AI framework utilizes prior observations of communications between the UE and the network node to predict the blockage condition.
Aspect 7 is the method of any of aspects 1-6, further includes that the ML or AI framework and associated optimizations are performed at the UE.
Aspect 8 is the method of any of aspects 1-7, further includes that the ML or AI framework and associated optimizations are performed within a second network node in communication with the UE.
Aspect 9 is the method of any of aspects 1-8, further includes that the corresponding beam at the network node is determined based on a correlation between a beam change at the UE and the corresponding beam at the network node.
Aspect 10 is the method of any of aspects 1-9, further including scheduling a beam change to the second beam based on the predicted blockage condition.
Aspect 11 is the method of any of aspects 1-10, further includes that the blockage condition is based on at least physical movements of a user using the UE or of the UE.
Aspect 12 is the method of any of aspects 1-11, further including switching to the second beam in response to transmitting the beam switch indication; and monitoring for an ACK from the network node acknowledging a switch to a corresponding beam at the network node.
Aspect 13 is the method of any of aspects 1-12, further includes that the beam switch indication comprises a request to switch beams to a corresponding beam at the network node associated with a predicted time scale.
Aspect 14 is the method of any of aspects 1-13, further includes that the predicted time scale corresponds with a start time of the predicted blockage condition.
Aspect 15 is an apparatus for wireless communication at a UE including at least one processor coupled to a memory and at least one transceiver, the at least one processor configured to implement any of Aspects 1-14.
Aspect 16 is an apparatus for wireless communication at a target UE including means for implementing any of Aspects 1-14.
Aspect 17 is a computer-readable medium storing computer executable code, where the code when executed by a processor causes the processor to implement any of Aspects 1-14.
Aspect 18 is a method of wireless communication at a network node comprising communicating with a UE using a first beam; and obtaining a beam switch indication comprising a scheduled change in a TCI state mapped from the first beam to a second beam for the UE based on a predicted blockage condition to the first beam.
Aspect 19 is the method of aspect 18, further includes that the beam switch indication indicates a corresponding beam at the network node that corresponds with the second beam of the UE.
Aspect 20 is the method of any of aspects 18 and 19, further includes that a corresponding beam at the network node is determined based on a correlation between the second beam at the UE and the corresponding beam at the network node that corresponds with the second beam at the UE.
Aspect 21 is the method of any of aspects 18-20, further including outputting an ACK acknowledging a switch to a corresponding beam that corresponds with the second beam at the UE.
Aspect 22 is the method of any of aspects 18-21, further includes that the beam switch indication comprises a request to switch beams to a corresponding beam at the network node associated with a predicted time scale.
Aspect 23 is the method of any of aspects 18-22, further includes that the predicted time scale corresponds with a start time of the predicted blockage condition.
Aspect 24 is an apparatus for wireless communication at a network node including at least one processor coupled to a memory and at least one transceiver, the at least one processor configured to implement any of Aspects 18-23.
Aspect 25 is an apparatus for wireless communication at a network node including means for implementing any of Aspects 18-23.
Aspect 26 is a computer-readable medium storing computer executable code, where the code when executed by a processor causes the processor to implement any of Aspects 18-23.

What is claimed is:

1. An apparatus for wireless communication at a user equipment (UE), comprising:
a memory; and
at least one processor coupled to the memory and, based at least in part on information stored in the memory, the at least one processor is configured to:
predict a blockage condition to a first beam communicating with a network node; and
transmit, to the network node, a beam switch indication indicating a scheduled change in a transmission configuration indicator (TCI) state mapped from the first beam to a second beam in response to the predicted blockage condition.

2. The apparatus of claim 1, further comprising a transceiver coupled to the at least one processor.

3. The apparatus of claim 1, wherein the beam switch indication indicates a corresponding beam at the network node that corresponds with the second beam of the UE.

4. The apparatus of claim 1, wherein the at least one processor is configured to:
correlate a beam change to the second beam at the UE with a corresponding beam change at the network node.

5. The apparatus of claim 4, wherein a correlation between the second beam at the UE and the corresponding beam change at the network node is based on an observation of communication between the UE and the network node to estimate a channel matrix between the UE and the network node.

6. The apparatus of claim 4, wherein a correlation between the second beam at the UE and the corresponding beam change at the network node is based on a machine learning (ML) or artificial intelligence (AI) framework.

7. The apparatus of claim 6, wherein the ML or AI framework utilizes prior observations of communications between the UE and the network node to predict the blockage condition.

8. The apparatus of claim 6, wherein the ML or AI framework and associated optimizations are performed at the UE.

9. The apparatus of claim 6, wherein the ML or AI framework and associated optimizations are performed within a second network node in communication with the UE.

10. The apparatus of claim 3, wherein the corresponding beam at the network node is determined based on a correlation between a beam change at the UE and the corresponding beam at the network node.

11. The apparatus of claim 1, wherein the at least one processor is configured to:
schedule a beam change to the second beam based on the predicted blockage condition.

12. The apparatus of claim 1, wherein the blockage condition is based on at least physical movements of a user using the UE or of the UE.

13. The apparatus of claim 1, wherein the at least one processor is configured to:
switch to the second beam in response to transmitting the beam switch indication; and
monitor for an acknowledgement (ACK) from the network node acknowledging a switch to a corresponding beam at the network node.

14. The apparatus of claim 1, wherein the beam switch indication comprises a request to switch beams to a corresponding beam at the network node associated with a predicted time scale.

15. The apparatus of claim 14, wherein the predicted time scale corresponds with a start time of the predicted blockage condition.

16. A method of wireless communication at a user equipment (UE), comprising:
predicting a blockage condition to a first beam communicating with a network node; and
transmitting, to the network node, a beam switch indication indicating a scheduled change in a transmission configuration indicator (TCI) state mapped from the first beam to a second beam in response to the predicted blockage condition.

17. The method of claim 16, further comprising:
correlating a beam change to the second beam at the UE with a corresponding beam change at the network node.

18. The method of claim 16, further comprising:
scheduling a beam change to the second beam based on the predicted blockage condition.

19. The method of claim 16, further comprising:
switching to the second beam in response to transmitting the beam switch indication; and
monitoring for an acknowledgement (ACK) from the network node acknowledging a switch to a corresponding beam at the network node.

20. An apparatus for wireless communication at a network node, comprising:
a memory; and
at least one processor coupled to the memory and, based at least in part on information stored in the memory, the at least one processor is configured to:
communicate with a user equipment (UE) using a first beam; and
obtain a beam switch indication comprising a scheduled change in a transmission configuration indicator (TCI) state mapped from the first beam to a second beam for the UE based on a predicted blockage condition to the first beam.

21. The apparatus of claim 20, further comprising a transceiver coupled to the at least one processor.

22. The apparatus of claim 20, wherein the beam switch indication indicates a corresponding beam at the network node that corresponds with the second beam of the UE.

23. The apparatus of claim 20, wherein a corresponding beam at the network node is determined based on a correlation between the second beam at the UE and the corresponding beam at the network node that corresponds with the second beam at the UE.

24. The apparatus of claim 20, wherein the at least one processor is configured to:
output an acknowledgment (ACK) acknowledging a switch to a corresponding beam that corresponds with the second beam at the UE.

25. The apparatus of claim 20, wherein the beam switch indication comprises a request to switch beams to a corresponding beam at the network node associated with a predicted time scale.

26. The apparatus of claim 25, wherein the predicted time scale corresponds with a start time of the predicted blockage condition.

27. A method of wireless communication at a network node, comprising:
communicating with a user equipment (UE) using a first beam; and
obtaining a beam switch indication comprising a scheduled change in a transmission configuration indicator (TCI) state mapped from the first beam to a second beam for the UE based on a predicted blockage condition to the first beam.

28. The method of claim 27, wherein the beam switch indication indicates a corresponding beam at the network node that corresponds with the second beam of the UE.

29. The method of claim 27, wherein a corresponding beam at the network node is determined based on a correlation between the second beam at the UE and the corresponding beam at the network node that corresponds with the second beam at the UE.

30. The method of claim 27, further comprising:
outputting an acknowledgment (ACK) acknowledging a switch to a corresponding beam that corresponds with the second beam at the UE.
